(19) United States
(12) Patent Application Publication
(10) Pub. No.: US 2012/0287078 A1
(43) Pub. Date: Nov. 15, 2012

(54) MULTI-TOUCH DETECTION METHOD AND DEVICE THEREOF

(75) Inventors: JAOCHING LIN, TAIPEI CITY (TW); LINABEL CHU, TAIPEI CITY (TW); PO-HSUN HUANG, TAIPEI CITY (TW)

(73) Assignee: SENTELIC CORPORATION, TAIPEI CITY 11493 (TW)

(21) Appl. No.: 13/461,050

(22) Filed: May 1, 2012

(30) Foreign Application Priority Data
May 9, 2011 (TW) 100116135

(51) Int. Cl. G06F 3/044

(52) U.S. Cl. 345/174

(57) ABSTRACT

A multi-touch detection method and device thereof includes multiple first electrode rows spacedly intersecting with multiple second electrode rows. The first and second electrical signals are applied respectively to each first electrode row and each second electrode row to detect capacitance variations of the first and second electrode rows so as to select first and second candidate electrode rows from the first and second electrode rows based on the capacitance variations. Individual third electrical signals are applied respectively to the first candidate electrode rows to detect capacitance variations of the second candidate electrode rows so as to determine real touched points on the touch screen.

### CROSS-REFERENCE TO RELATED APPLICATION

This application claims priority to Taiwanese Application No. 100116135, filed on May 9, 2011.

### BACKGROUND OF THE INVENTION

1. Field of the Invention

The invention relates to a touch detection method and device for a touch pad, and more particularly to a Multi-touch Detection Method and Device thereof.

2. Description of the Related Art

With providing of multi-touch functional products in the market, touch sensing component, like capacitive touch screen, become very important in the industry.

Traditionally, capacitive touchscreens achieves touch sensing function by performing capacitance measurement in mainly two ways: self-inductance and mutual inductance.

Mentioned self-inductance, please referring to FIG. 1, when using self-inductance, the step comprises i.e., applying electrical signal to each of X-directional electrode rows (X1˜X4) simultaneously and sensing capacitance of each of electrode rows (X1˜X4), and applying electrical signal to each of the Y-directional electrode rows (Y1˜Y7) and sensing capacitance of each of the electrode rows (Y1˜Y7).

Once a finger touch is on the touch screen, for example, capacitance variations of electrode rows (X2, X4, Y3, Y5) are detected. In such, touch events are determined to occur at positions (X2, Y3), (S2, Y5), (X4, Y3), and (X4, Y5).

However, in fact, only the points at (X2, Y3) and (X4, Y5) are real touched points, whereas the points at (X2, Y5) and (X4, Y3) are non-real touched points. Mentioned non-real touched points, in the industry, are commonly regard as “ghost points”. Thus, a problem is existing in the self-inductance that it cannot correctly determine the real touched points, plus additional complicated mathematical operations are required. Foreseeably, in this case, it is required to tediously scan the electrode rows (X1˜X4, Y1˜Y7) for 11 times (4 times for the electrode rows (X1˜X4), and 7 times for the electrode rows (Y1˜Y7)).

In order to solve the problems of ghost points, mutual-inductance as show in FIG. 2 is provided. Referring to FIG. 2, when using mutual-inductance, step may comprise: applying an electrical signal to each of the X-directional electrode rows (X1˜X4) in sequence and detecting capacitance of each of the Y-directional electrode rows (Y1˜Y7) in response to each application of the electrical signal, capacitance variations corresponding to electrode rows (X2, X4, Y3, Y5) are detected, with such, the real touch occurs at (X2, Y3) and (X4, Y5) is determined. In this case, it is required to scan the electrode rows (Y1˜Y7) for 28(=7×4) times. The mutual-inductance resolves the ghost point problem, however, with more times of scanning, the mutual-inductance thus inevitably increases power consumption. In addition, since the capacitance variation between the electrode rows (X2, Y3) and the electrode rows (X4, Y5) are relatively small, external noise interference may result in error of determination.

Therefore, improvements may be made to the above techniques.

### SUMMARY OF THE INVENTION

Therefore, an object of the present invention is to provide a multi-touch detection method and device that can overcome the aforesaid drawbacks of the prior art.

According to one aspect of the present invention, a multi-touch detection method and device thereof is provided. The multi-touch detection device includes a plurality of first electrode rows arranged along a first direction and a plurality of second electrode row arranged along a second direction transverse to the first direction. Each of the first electrode rows has a plurality of a plurality of first electrodes connected in series and extends in the second direction. Each of the second electrode rows has a plurality of second electrodes connected in series and extends in the first direction.

The second electrode rows are spacedly intersecting with the first electrode rows.

The method is applying to a touch screen having a plurality of first electrode rows and a plurality of second electrode rows, the method comprises the steps of:

a) applying a first electrical signal to each of the first electrode rows and detecting capacitance variations of the first electrode rows, applying a second electrical signal to each of the second electrode rows and detecting capacitance variations of the second electrode rows, and determining at least one first candidate electrode row from the first electrode rows and at least one second candidate electrode row from the second electrode rows based on the capacitance variations; and

b) applying third electrical signals to the first candidate electrode row and detecting capacitance variations at the second candidate electrode rows, and determining real touched positions on the device based on the capacitance variations.

According to another aspect of the present invention, a multi-touch detection method and device thereof is provided. The touch screen includes a plurality of first electrode rows arranged along a first direction and extending in a second direction transverse to the first direction, and a plurality of second electrode row arranged along the second direction, extending in the first direction and spacedly intersecting with the first electrode rows. Each of the first electrode rows has a plurality of first electrodes connected in series. Each of the second electrode rows has a plurality of second electrodes connected in series. The method comprising the steps of:

a) detecting capacitance variations of first self-inductional capacitances at each of the first electrode rows, and capacitance variations of second self-inductional capacitances at each of the second electrode rows and to determine multiple first candidate electrode rows from the first electrode rows and multiple second candidate electrode rows from the second electrode rows based on the capacitance variations of the first self-inductional capacitances and the capacitance variations of the second self-inductional capacitances;

b) detecting capacitance variations at each of the second candidate electrode rows so as to determine, based on the capacitance variations of the mutual-inductional capacitances, real touched points on the touch screen, which correspond respectively to the fingers touching on the touch screen.

For more clarity of description, above mentioned self-inductional capacitance and mutual-inductional capacitance are further illustrated in below:

The self-inductional capacitance means the capacitance that is measured in traditional self-induction measurement manner, in present embodiment, may be obtained at the electrode rows which electrical signal is applying. The mutual-inductional capacitance means the capacitance that is measure in traditional mutual-induction measurement, in present embodiment, may be obtained at the electrode rows which electrical signal is not applying.

According to a further aspect of the present invention, a multi-touch detection method and device thereof is provided. The touch screen includes a plurality of first electrode rows arranged along a first direction and extending in a second direction transverse to the first direction, and a plurality of second electrode row arranged along the second direction, extending in the first direction and spacedly intersecting with the first electrode rows. Each of the first electrode rows has a plurality of first electrodes connected in series. Each of the second electrode rows has a plurality of second electrodes connected in series. The multi-touch detection device comprises:

a controller adapted to be coupled to the first electrode rows and the second electrode rows of the touch screen.

During touching of multiple fingers on the touch screen, the controller is configured to

detect capacitance variations of first self-inductional capacitances at each of the first electrode rows, and capacitance variations of second self-inductional capacitances at each of the second electrode rows so as to determine multiple first candidate electrode rows from the first electrode rows and multiple second candidate electrode rows from the second electrode rows based on the capacitance variations of the first self-inductional capacitances and the capacitance variations of the second self-inductional capacitances, and

detect capacitance variations of mutual-inductional capacitances at each of the second candidate electrode rows so as to determine, based on the capacitance variations of the mutual-inductional capacitances, real touched points on the touch screen, which correspond respectively to the fingers touching on the touch screen.

According to still another aspect of the present invention, a touch device comprises:

a touch screen including
a substrate having opposite surfaces,
a plurality of first electrode rows formed on one of the surfaces of the substrate, arranged along a first direction and extending in a second direction transverse to the first direction, each of the first electrode rows having a plurality of first electrodes connected in series, and
a plurality of second electrode row formed on the other one of the surface of the substrate, arranged along the second direction, extending in the first direction and spacedly intersecting with the first electrode rows, each of the second electrode rows having a plurality of second electrodes connected in series; and

a controller coupled to the first electrode rows and the second electrode rows of the touch screen.

During touching of multiple fingers on the touch screen, the controller is configured to

detect capacitance variations of first self-inductional capacitances at each of the first electrode rows, and capacitance variations of second self-inductional capacitances at each of the second electrode rows so as to determine multiple first candidate electrode rows from the first electrode rows and multiple second candidate electrode rows from the second electrode rows based on the capacitance variations of the first self-inductional capacitances and the capacitance variations of the second self-inductional capacitances, and

detect capacitance variations of mutual-inductional capacitances at each of the second candidate electrode rows so as to determine, based on the capacitance variations of the mutual-inductional capacitances, real touched points on the touch screen, which correspond respectively to the fingers touching on the touch screen.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view illustrating multi-touch detection using self-inductance;

FIG. 2 is a schematic view illustrating multi-touch detection using mutual-inductional capacitance sensing;

FIG. 3 is a schematic view showing a touch device that is configured for implementing the preferred embodiment of a multi-touch detection method according to the present invention;

FIG. 4 is a flow chart illustrating the preferred embodiment;

FIG. 5 is a schematic view illustrating a touch screen of the touch device when in an operation of two touched points;

FIG. 6 is an equivalent circuit diagram illustrating the touch screen when in the first operation;

FIG. 7 is an equivalent circuit diagram illustrating first and second candidate electrode rows selected from the touch screen when in the first operation;

FIG. 8 is a schematic view illustrating a variation of the touch screen of the touch device when in an operation of three touched points;

FIG. 9 is an equivalent circuit diagram illustrating the variation of the touch screen when in the second operation; and

FIG. 10 is an equivalent circuit diagram illustrating first and second candidate electrode rows selected from the variation of the touch screen when in the second operation.

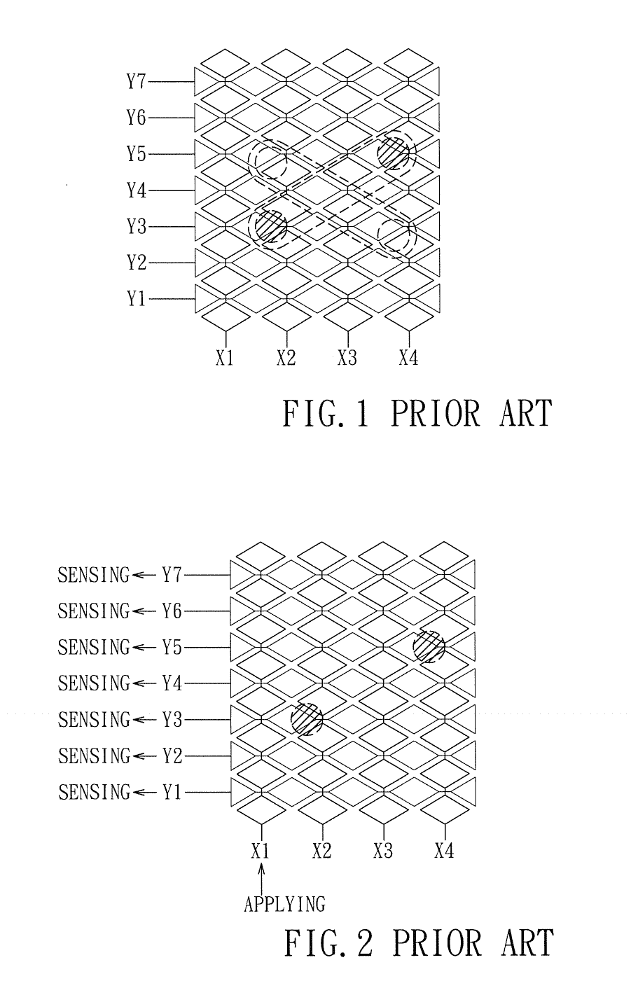

### DETAILED DESCRIPTION OF THE PREFERRED EMBODIMENT

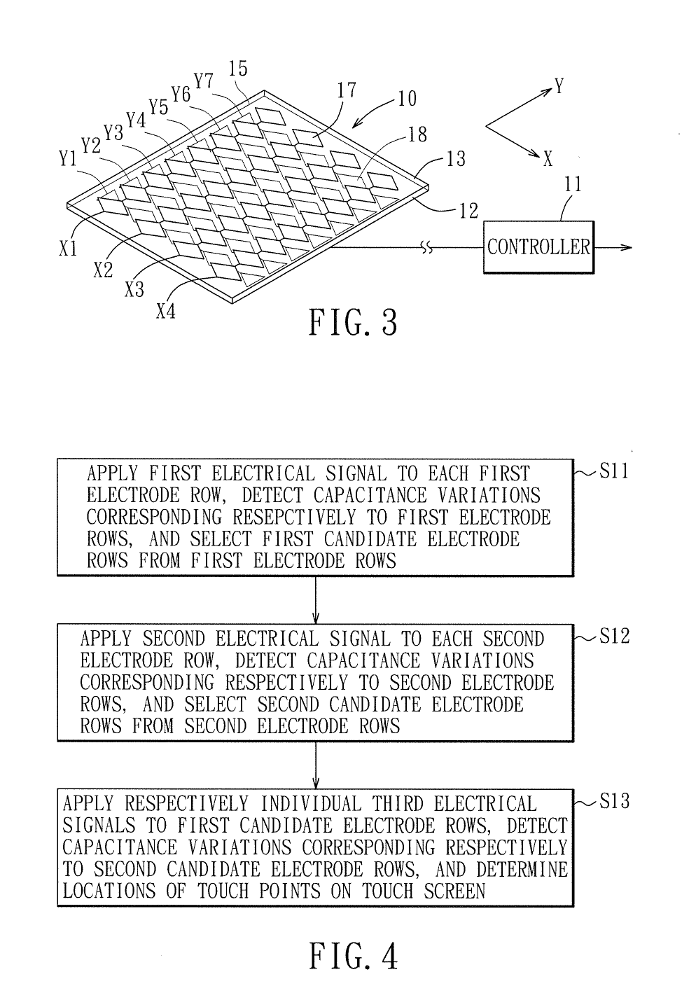

Referring to FIG. 3, a touch device that is configured for implementing the preferred embodiment of a multi-touch detection method and device thereof according to the present invention is shown to include a touch screen 10, and a controller 11.

The touch screen 10 includes a substrate 12, such as a transparent glass substrate, a first ITO conductive film 13 formed on a first surface of the substrate 12, and a second ITO conductive film 15 formed on a second surface of the substrate 12 opposite to the first surface. The first conductive film 13 is formed with a plurality of first electrode rows (X1˜X4) arranged along a first direction (X) and extending in a second direction (Y) transverse to the first direction (X). The second conductive film 15 is formed with a plurality of second electrode rows (Y1˜Y7) arranged along the second direction (Y), extending in the first direction (X) and spacedly intersecting with the first electrode rows (X1˜X4). Each of the first electrode rows (X1˜X4) has a plurality of first electrodes 17 connected in series. Each of the second electrode rows (Y1˜Y7) has a plurality of second electrodes 18 connected in series.

The controller 11 is connected electrically to the first electrode rows (X1˜X4) and the second electrode rows (Y1˜Y7).

FIG. 3 illustrates a flow chart of the preferred embodiment of the multi-touch detection method for the touch screen 10 of the touch device.

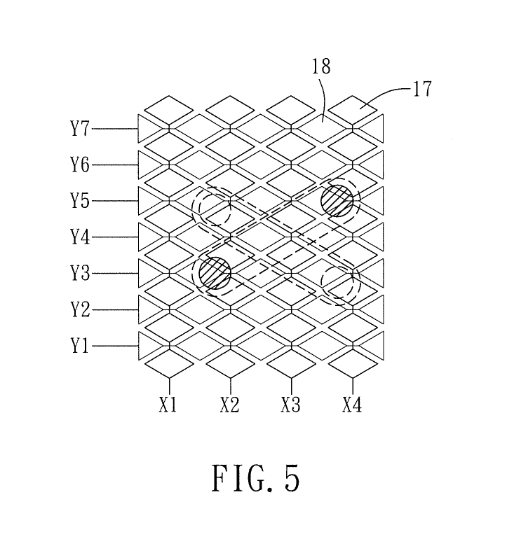

In step S1, during touching of multiple fingers on the touch screen 10, for example, as shown in FIG. 5, two touch events occur at points at (X2, Y3) and (X4, Y5) indicated by solid lines, the controller 11 detects capacitance variations at each of the first electrode rows (X1˜X4) using self-inductance, and selects multiple first candidate electrode rows from the first electrode rows (X1˜X4) based on the capacitance variations at each of the first electrode rows (X1˜X4). In detail, the controller 11 applies a first electrical signal to each of the first electrode rows (X1˜X4) to measure first sensed capacitances of the first electrode rows (X1˜X4), and detects the capacitance variations at each of the first electrode rows (X1˜X4) based on the first sensed capacitances measured thereby. In this case, the first sensed capacitances serve as first self-inductional capacitances. It is noted that, in this embodiment, when the first electrical signal is applied to each of the first electrode rows (X1˜X4), the second electrode rows (Y1˜Y7) are grounded. In addition, the first electrode rows (X1˜X4) receive sequentially the first electrical signal from the controller 11 such that the first electrode rows (X1˜X4) are charged sequentially with the first electrical signal. Upon charging any one of the first electrode rows (X1˜X4), the other ones of the first electrode rows (X1˜X4) are grounded. Alternatively, upon charging of any one of the first electrode rows (X1˜X4), at most two of the other ones of the first electrode rows (X1˜X4) adjacent to said any one of the first electrode rows (X1˜X4) are grounded. In other embodiments, the first electrode rows (X1˜X4) receive simultaneously the first electrical signal from the controller 11 such that the first electrode rows (X1˜X4) are charged simultaneously with the first electrical signal.

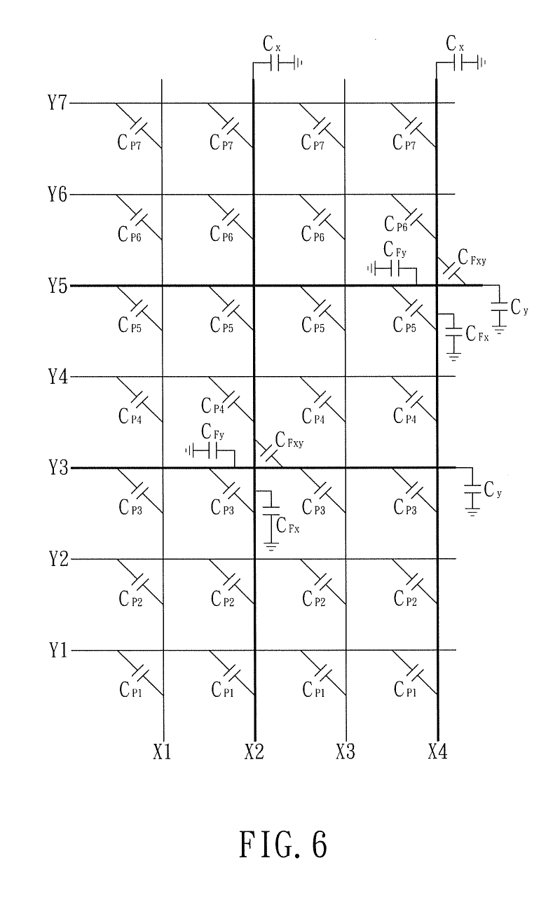

Referring to FIG. 6, for each of the first electrode rows (X1˜X4), a coupling capacitance (Cₚ₁˜Cₚ₇) exists between each first electrode 17 and a corresponding second electrode of each of the second electrode rows (Y1˜Y7). Furthermore, a coupling capacitance (Cₓ) exists between each of the first electrode rows (X1˜X4) and ground. As such, prior to touch operation, each of the first electrode rows (X1˜X4) has a first sensed capacitance (Cs) that is fixed in this case, wherein Cs=Cₚₜₐₗ=Cₓ+Cₚ₁+Cₚ₂+ . . . +Cₚ₇. Upon touching of two fingers on the touch screen 10 at the points of (X2, Y3) and (X4, Y5), a finger coupling capacitance (C_{Fx}) exists between each of the first electrode rows (X2, X4) and a corresponding finger and is connected in parallel to the coupling capacitances (Cₚ₁˜Cₚ₇), and an intersection point coupling capacitance (C_{Fxy}) exists between each of the points of (X2, Y3) and (X4, Y5), and a corresponding finger. In this case, the first sensed capacitance (Cs) of each of the first electrode rows (X2, X4) increases, wherein Cs=Cₚₜₐₗ+C_{Fxy}+C_{Fx}, i.e., the capacitance variations exist in the first electrode rows (X2, X4), whereas the first sensed capacitances of the first electrode rows (X1, X3) remain unchanged, i.e., no capacitance variation exists in the first electrode rows (X1, X3). Therefore, the controller 11 determines based on the capacitance variations that the touch events occur at the first electrode rows (X2, X4), and thus selects the first electrode rows (X2, X4) as the first candidate electrode rows.

In step S2, similar to step S1, the controller 11 detects capacitance variations at each of the second electrode rows (Y1˜Y7) using self-inductance, and selects multiple second candidate electrode rows from the second electrode rows (Y1˜Y7) based on the capacitance variations at each of the second electrode rows (Y1˜Y7). In detail, the controller 11 applies a second electrical signal to each of the second electrode rows (Y1˜Y7) to measure second sensed capacitances at each of the second electrode rows (Y1˜Y7), and detects capacitance variations of the first sensed capacitances. In this case, the second sensed capacitances serve as second self-inductional capacitances. When the second electrical signal is applied to each of the second electrode rows (Y1˜Y7), the first electrode rows (X1˜X4) are grounded. Upon charging any one of the second electrode rows (Y1˜Y7), the other ones of the second electrode rows (Y1˜Y7) are grounded. As shown in FIG. 6, a coupling capacitance (C_{y}) exists between each of the second electrode rows (Y1˜Y7) and ground. As such, prior to touch operation, each of the second electrode rows (Y1˜Y7) has a second sensed capacitance (Cs′) that is fixed in this case, wherein Cs′=Cₚₜₐₗ′=C_{y}+4Cₚₙ, where n=1, . . . , 7. Upon touching of two fingers on the touch screen 10 at the points of (X2, Y3) and (X4, Y5), a finger coupling capacitance (C_{Fy}) exists between each of the second electrode rows (X2, X4). The intersection point coupling capacitance (C_{Fxy}) exists between each of the points of (X2, Y3) and (X4, Y5) and the corresponding finger. In this case, the second sensed capacitance (Cs′) of each of the second electrode rows (Y3, Y5) increases, wherein Cs′=Cₚₜₐₗ′+C_{Fxy}+C_{Fy}, i.e., the capacitance variations exist in the second electrode rows (Y3, Y5), whereas the second sensed capacitances of the second electrode rows (Y1, Y2, Y4, Y6, Y7) remain unchanged, i.e., no capacitance variation exists in the second electrode rows (Y1, Y2, Y4, Y6, Y7). Therefore, the controller 11 determines, based on the capacitance variations, that the touch events occur at the second electrode rows (Y3, Y5), and thus selects the second electrode rows (Y3, Y4) as the second candidate electrode rows.

In step S3, the controller 11 detects capacitance variations at each of at least the second candidate electrode rows using mutual-inductional capacitance sensing, and determines, based on the capacitance variations at each of at least the second candidate electrode rows (Y3, Y5), real touched points on the touch screen 10. In order to minimize the number of times of scanning, in this embodiment, only the capacitance variations at each of the second candidate electrode rows (Y3, Y5) are detected. In other embodiments, not only the capacitance variations corresponding to the second candidate electrode rows (Y3, Y5) but capacitance variations corresponding to the other second electrode rows (Y1, Y2, Y4, Y6, Y7) can also be detected. In detail, the controller 11 applies respectively individual third electrical signals to the first candidate electrode rows, i.e., the first electrode rows (X2, X4), to measure third sensed capacitances of the second candidate electrode rows, i.e., the second electrode rows (Y3, Y5), in response to each of the third electrical signals being applied to a corresponding one of the first candidate electrode rows (X2, X4), and detects capacitance variations at each of the second candidate electrode rows (Y3, Y5) based on the third sensed capacitances measured thereby. In this case, the third sensed capacitances serve as mutual-inductional capacitances. In this embodiment, the third electrical signals may be identical to each other. The third electrical signals are applied respectively and sequentially to the first candidate electrode rows (X2, X4) such that the third sensed capacitances of the second candidate electrode rows (Y3, Y5) are measured sequentially. In other embodiments, each of the third electrical signals is an AC electrical signal with a phase and a frequency, such as a triangular wave signal, a sine wave signal, a square wave signal or a PWM signal. Each of the third electrical signals differs from the other third electrical signals in at least one of the phase and the frequency.

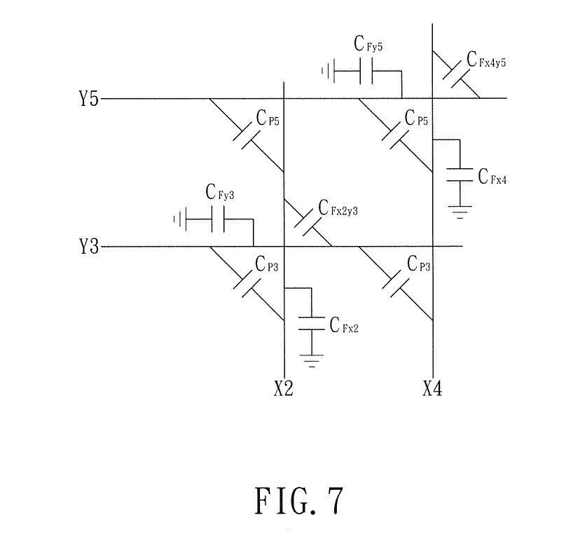

Referring to FIG. 7, the coupling capacitance (Cₚ₃, Cₚ₅) exist respectively in the points of (X2, Y3) and (X4, Y5). Upon touching of the two fingers on the touch screen 10, the controller 11 first applies the individual third electrical signal to the first candidate electrode row (X4) to measure the third sensed capacitances of the second candidate electrode rows (Y3, Y5). In this case, an intersection point coupling capacitance (C_{Fx2y3}) exists between a corresponding finger and the point of (X2, Y3), and two finger coupling capacitance (C_{Fx2}, C_{Fy3}) exist respectively between the corresponding finger and the first candidate electrode row (X2), and between the corresponding finger and the second candidate electrode row (Y3). As a result, the third sensed capacitance of the second candidate electrode row (Y3) changes, i.e., the capacitance variation exist in the second candidate electrode rows (Y3), whereas the third sensed capacitance of the second candidate electrode row (Y5) remain unchanged, i.e., no capacitance variation exists in the second candidate electrode rows (Y5). Therefore, the controller 11 determines that one touched point is located at the point of (X2, Y3). Then, the controller 11 applies the individual third electrical signal to the first candidate electrode row (X4) to measure the third sensed capacitances of the second candidate electrode rows (Y3, Y5). In this case, an intersection point coupling capacitance (C_{Fx4y5}) exists between a corresponding finger and the point of (X4, Y5), and two finger coupling capacitance (C_{Fx4}, C_{Fy5}) exist respectively between the corresponding finger and the first candidate electrode row (X4), and between the corresponding finger and the second candidate electrode row (Y5). As a result, the third sensed capacitance of the second candidate electrode row (Y5) changes, i.e., the capacitance variation exist in the second candidate electrode rows (Y5), whereas no capacitance variation exists in the second candidate electrode rows (Y5). Therefore, the controller 11 determines that another touched point is located at the point of (X4, Y5).

Therefore, in this embodiment, the two-touch detection can be exactly completed by the multi-touch detection method through scanning of 15 (=4+7+2×2) times, wherein 4 times for the first sensed capacitances, 7 times for the second sensed capacitances, and 4 time for the third sensed capacitances, thereby reducing the number of times of scanning and power consumption as compared to the prior art using mutual-inductional capacitance sensing. In addition, the multi-touch detection method of the present invention can exactly determine real touched points on the touch screen without the complicated mathematical operations required in the prior art that used self-inductance.

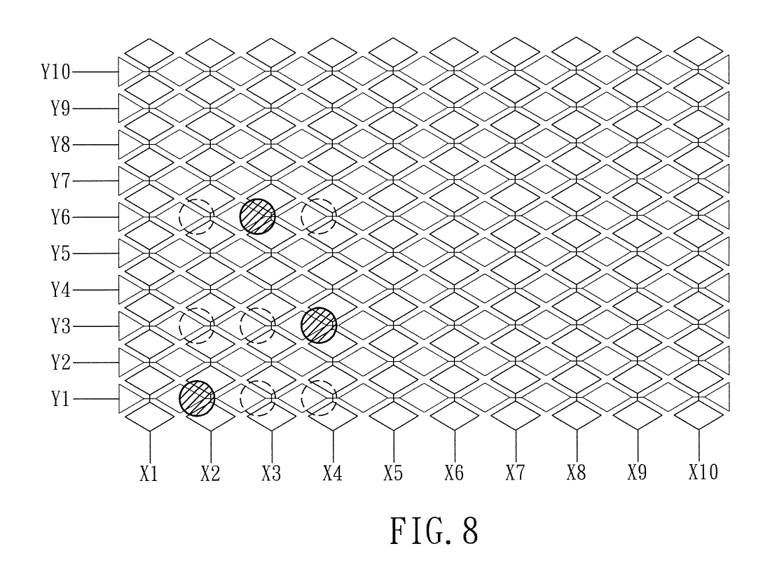

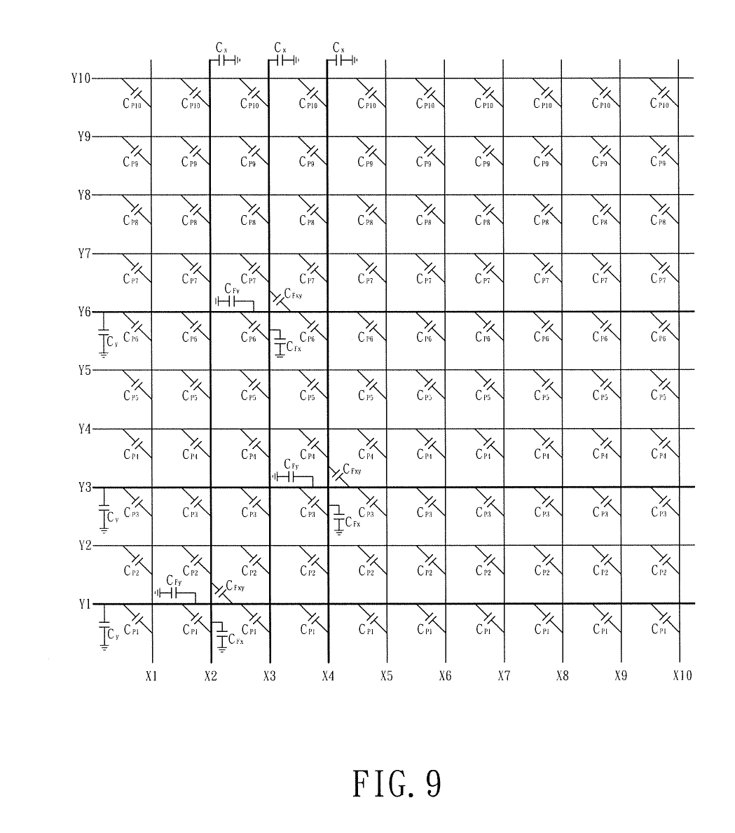

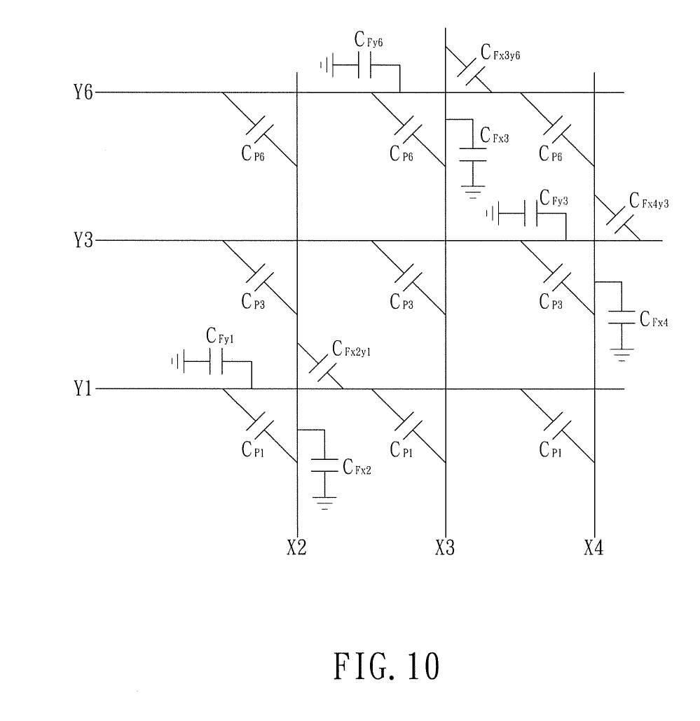

FIG. 8 illustrates a variation of the touch screen of the touch device including ten first electrode rows (X1˜X10) and ten second electrode rows (Y1˜Y10) when in an operation of three touched points as indicated by solid lines. According to the multi-touch detection method of the preferred embodiment, referring to FIG. 9, using self-inductance, the first candidate electrode rows (X2, X3, X4) are selected in step S1 by the controller 11, and the second candidate electrode rows (Y1, Y3, Y6) are selected in step S2 by the controller 11. Referring to FIG. 10, locations of three touched points are determined to be the points of (X2, Y1), X3, Y6) and (X4, Y3) in step S3 by the controller 11 using mutual-inductional capacitance sensing. Therefore, in this operation, the three-touch detection can be exactly completed by the multi-touch detection method through scanning of 29(=10+10+3×3) times, wherein 10 times for the first sensed capacitances, 10 times for the second sensed capacitances, and 9 time for the third sensed capacitances, that is greatly reduced as compared to scanning of 100 (=10×10) times required in the prior art using mutual-inductional capacitance sensing for the same operation.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A multi-touch detection method applying to a touch screen having a plurality of first electrode rows and a plurality of second electrode rows, the method comprises the steps of:
a) applying a first electrical signal to each of the first electrode rows and detecting capacitance variations of the first electrode rows, applying a second electrical signal to each of the second electrode rows and detecting capacitance variations of the second electrode rows, and determining at least one first candidate electrode row from the first electrode rows and at least one second candidate electrode row from the second electrode rows based on the capacitance variations; and
b) applying third electrical signals to the first candidate electrode row and detecting capacitance variations at the second candidate electrode rows, and determining real touched positions on the device based on the capacitance variations.

2. The multi-touch detection method as claimed in claim 1, wherein, in step a):
when the first electrical signals is applied to each of the first electrode rows, the second electrode rows are grounded; and
when the second electrical signal is applied to each of the second electrode rows, the first electrode rows are grounded.

3. The multi-touch detection method as claimed in claim 1, wherein, in step b);
the third electrical signals are identical to each other; and
the third electrical signals are applied respectively to the first candidate electrode rows and corresponding third sensed capacitances are measured at the second candidate electrode rows, so as to detect the capacitance variations at the second candidate electrode rows.

4. The multi-touch detection method as claimed in claim 1, wherein, in step b):
the third electrical signals are different from each other; and
the third electrical signals are applied respectively to the first candidate electrode rows and corresponding third sensed capacitances are measured at the second candidate electrode rows, so as to detect the capacitance variations at the second candidate electrode rows.

5. The multi-touch detection method as claimed in claim 4, wherein:
each of the third electrical signals is an AC electrical signal with a phase and a frequency; and
each of the third electrical signals differs from the other ones of the third electrical signals in at least one of the phase and the frequency.

6. The multi-touch detection method as claimed in claim 1, wherein, in step a), the first electrode rows are charged sequentially with the first electrical signal.

7. The multi-touch detection method as claimed in claim 6, wherein, upon charging any one of the first electrode rows, the other ones of the first electrode rows are grounded.

8. The multi-touch detection method as claimed in claim 6, wherein, upon charging any one of the first electrode rows, at most two of the other ones of the first electrode rows adjacent to said any one of the first electrode rows are grounded.

9. The multi-touch detection method as claimed in claim 1, wherein, in step a), the first electrode rows are charged simultaneously with the first electrical signal.

10. A multi-touch detection method applying on a touch screen including a plurality of first electrode rows and a plurality of second electrode row spacedly intersecting with the first electrode rows, said multi-touch detection method comprising the steps of:
a) detecting capacitance variations of first self-inductional capacitances at each of the first electrode rows, and capacitance variations of second self-inductional capacitances at each of the second electrode rows so as to determine multiple first candidate electrode rows from the first electrode rows and multiple second candidate electrode rows from the second electrode rows based on the capacitance variations of the first self-inductional capacitances and the capacitance variations of the second self-inductional capacitances;
b) detecting capacitance variations of mutual-inductional capacitances at each of the second candidate electrode rows so as to determine real touched points on the touch screen, which correspond respectively to the fingers touching on the touch screen, based on the capacitance variations of the mutual-inductional capacitances.

11. A multi-touch detection device comprising:
a touch screen including a plurality of first electrode rows arranged along a first direction and extending in a second direction transverse to the first direction, and a plurality of second electrode rows arranged along the second direction, extending in the first direction and spacedly intersecting with the first electrode rows;
a controller adapted to be coupled to the first electrode rows and the second electrode rows of the touch screen;
wherein, said controller is configured to
detect capacitance variations of first self-inductional capacitances at each of the first electrode rows, and capacitance variations of second self-inductional capacitances at each of the second electrode rows so as to determine multiple first candidate electrode rows from the first electrode rows and multiple second candidate electrode rows from the second electrode rows based on the capacitance variations of the first self-inductional capacitances and the capacitance variations of the second self-inductional capacitances, and
detect capacitance variations of mutual-inductional capacitances at each of the second candidate electrode rows so as to determine, based on the capacitance variations of the mutual-inductional capacitances, real touched points on the touch screen, which correspond respectively to the fingers touching on the touch screen.

12. The multi-touch detection device as claimed in claim 11, wherein:
said controller is configured to measure the first self-inductional capacitances after applying a first electrical signal to each of the first electrode rows;
said controller is configured to measure the second self-inductional capacitances after applying a second electrical signal to each of the second electrode rows; and
said controller is configured to measure the mutual-inductional capacitances after applying an individual third electrical signals to each of the first candidate electrode rows.

13. The multi-touch detection device as claimed in claim 12, wherein:
when said controller applies the first electrical signal to each of the first electrode rows to charge each of the first electrode rows with the first electrical signal, said controller is configured to enable the second electrode rows to be grounded; and
when said controller applies the second electrical signal to each of the second electrode rows to charge each of the second electrode rows with the second electrical signal, said controller is configured to enable the first electrode rows to be grounded.

14. The multi-touch detection device as claimed in claim 12, wherein:
the third electrical signals are identical to each other; and
said controller applies respectively and sequentially the third electrical signals to the first candidate electrode rows such that the mutual-inductional capacitances corresponding each of the second candidate electrode rows are measured sequentially.

15. The multi-touch detection device as claimed in claim 12, wherein:
the third electrical signals are different from each other; and
said controller applies respectively and simultaneously the third electrical signals to the first candidate electrode rows such that the mutual-inductional capacitances at each of the second candidate electrode rows are measured simultaneously.

16. The multi-touch detection device as claimed in claim 15, wherein:
each of the third electrical signals is an AC electrical signal with a phase and a frequency; and
each of the third electrical signals differs from the other ones of the third electrical signals in at least one of the phase and the frequency.

17. A touch device comprising:
a touch screen including
a substrate having opposite surfaces,
a plurality of first electrode rows formed on one of said surfaces of said substrate, arranged along a first direction and extending in a second direction transverse to the first direction, each of said first electrode rows having a plurality of first electrodes connected in series, and
a plurality of second electrode row formed on the other one of said surface of said substrate, arranged along the second direction, extending in the first direction and spacedly intersecting with the first electrode rows, each of said second electrode rows having a plurality of second electrodes connected in series; and
a controller coupled to said first electrode rows and said second electrode rows of said touch screen;
wherein, during touching of multiple fingers on said touch screen, said controller is configured to
detect capacitance variations of first self-inductional capacitances at each of said first electrode rows, and capacitance variations of second self-inductional capacitances at each of said second electrode rows so as to determine multiple first candidate electrode rows from said first electrode rows and multiple second candidate electrode rows from said second electrode rows based on the capacitance variations of the first self-inductional capacitances and the capacitance variations of the second self-inductional capacitances, and
detect capacitance variations of mutual-inductional capacitances at each of the second candidate electrode rows so as to determine, based on the capacitance variations of the mutual-inductional capacitances, real touched points on the touch screen, which correspond respectively to the fingers touching on said touch screen.

18. The touch device as claimed in claim 17, wherein:
said controller is configured to measure the first self-inductional capacitances after applying a first electrical signal to each of said first electrode rows;
said controller is configured to measure the second self-inductional capacitances after applying a second electrical signal to each of said second electrode rows; and
said controller is configured to measure the mutual-inductional capacitances after applying an individual third electrical signals to each of the first candidate electrode rows.

19. The touch device as claimed in claim 18, wherein:
when said controller applies the first electrical signal to each of said first electrode rows to charge each of said first electrode rows with the first electrical signal, said controller is configured to enable said second electrode rows to be grounded; and
when said controller applies the second electrical signal to each of said second electrode rows to charge each of said second electrode rows with the second electrical signal, said controller is configured to enable said first electrode rows to be grounded.

20. The touch device as claimed in claim 18, wherein:
the third electrical signals are identical to each other; and
said controller applies respectively and sequentially the third electrical signals to the first candidate electrode rows such that the mutual-inductional capacitances corresponding each of the second candidate electrode rows are measured sequentially.

21. The touch device as claimed in claim 18, wherein:
the third electrical signals are different from each other; and
said controller applies respectively and simultaneously the third electrical signals to the first candidate electrode rows such that the mutual-inductional capacitances at each of the second candidate electrode rows are measured simultaneously.

22. The touch device as claimed in claim 21, wherein:
each of the third electrical signals is an AC electrical signal with a phase and a frequency; and
each of the third electrical signals differs from the other ones of the third electrical signals in at least one of the phase and the frequency.
